(19) United States
(12) Patent Application Publication
(10) Pub. No.: US 2022/0127162 A1
(43) Pub. Date: Apr. 28, 2022

(54) WATER PRESSURE MONITORING SYSTEM

(71) Applicant: KETO A.I, INC., Houston, TX (US)

(72) Inventors: Andrew D. HIGGINS, Houston, TX (US); Jeffrey S. JENSEN, Houston, TX (US); Bradley P. DRAKE, Minneapolis, MN (US)

(21) Appl. No.: 17/078,562

(22) Filed: Oct. 23, 2020

(51) Int. Cl. C02F 1/00; C02F 1/40; B01D 29/60

(52) U.S. Cl. CPC C02F 1/008; C02F 1/001; C02F 1/40; C02F 2103/42; C02F 2209/03; C02F 2201/009; C02F 2209/40; B01D 29/606

(57) ABSTRACT

A method and apparatus for monitoring a water pressure in a filter tank are disclosed. The apparatus may include a pressure sensor disposed within a housing and configured to monitor the water pressure in the filter tank. The apparatus may also include a controller disposed within the housing, the controller communicatively connected to the pressure sensor and the controller configured to receive a sensor signal from the pressure sensor, and to determine the water pressure in the filter tank based on the sensor.

### BACKGROUND

### Field of Disclosure

Embodiments of the present disclosure generally relate to water pressure monitoring systems. More specifically, the disclosure relates to systems for monitoring the upstream pressure of a filter system.

### Description of the Related Art

Typical pool systems include a filter for removing dirt, debris and general containments from the water. Over time, these filters clog and require cleaning to improve filter efficiency and water flow. Improperly cleaned filters lead to reduced water flow resulting in high pressure at the filter intake. Most filters include an analog gauge to measure the filter pressure visually. Improper maintenance of pool filters will result in a pool with a high suspended particulate load creating an environment for bacteria and algae to grow.

Currently, the most common way to measure filter pressure is through visual monitoring at the filter tank. A typical filter tank has a thread using the national pipe thread (NPT) standard at the top or in the front of the tank to mount an analog gauge. This method requires a person to visually note the pressure reading and determine if the flowing pressure is adequate based on the pump size, filter type and piping arrangement. Some electrical monitoring systems have appeared on the market but have not taken into consideration the analytical calculations needed to determine proper pressures required for proper flow. These devices are also not connected to a Bluetooth, WiFi or other wireless network to enable remote monitoring capabilities for third party technicians or pool cleaning and service companies.

Filter systems come in varying sizes and types which are matched with different types and sizes of pumps and other systems that can make it difficult to determine the optimal filter water pressure. As other smart systems enter the market, and equipment specification databases become connected to provide optimal running conditions, there becomes a need to utilize other smart devices and cloud software platforms to determine optimum filter pressures providing the correct information to the home owner or service company on when to ultimately service a filter.

Thus, there is a need for improved pressure monitoring systems.

### SUMMARY

The present disclosure generally relates to water pressure monitoring systems. More specifically, the disclosure relates to systems for automatically monitoring water pressure upstream of the filter in a filter tank.

In one embodiment, an apparatus for monitoring water pressure is provided, the apparatus including a housing, a pressure sensor disposed within the housing and an inlet conduit for the sensor, typically an NPT thread connection.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, as the disclosure may admit to other equally effective embodiments.

FIG. 1 is a diagram illustrating an example schematic arrangement of a pool system, according to one embodiment.

FIG. 2 is a block diagram of an example pressure monitoring device, according to an exemplary embodiment.

FIGS. 3A and 3B are perspective views illustrating the front and back views of the example pressure monitoring device, according to an exemplary embodiment.

FIGS. 4A and 4B are perspective views illustrating the internal components of the example pressure monitoring device, according to an exemplary embodiment.

FIG. 5 is a flow diagram of an exemplary method for using a pressure monitoring device, according to an exemplary embodiment.

FIG. 6 is an exemplary graphic user interface (GUI) for using a pressure monitoring system, according to an exemplary embodiment.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure generally relates to water pressure monitoring systems. More specifically, the disclosure relates to systems for automatically monitoring water pressure in a pool filter tank, as part of a swimming pool cleaning system. Exemplary embodiments described herein relate to an automatic water pressure sensor. Some exemplary embodiments relate to the automatic water pressure sensor used in conjunction with a level sensor coupled to a refill valve system.

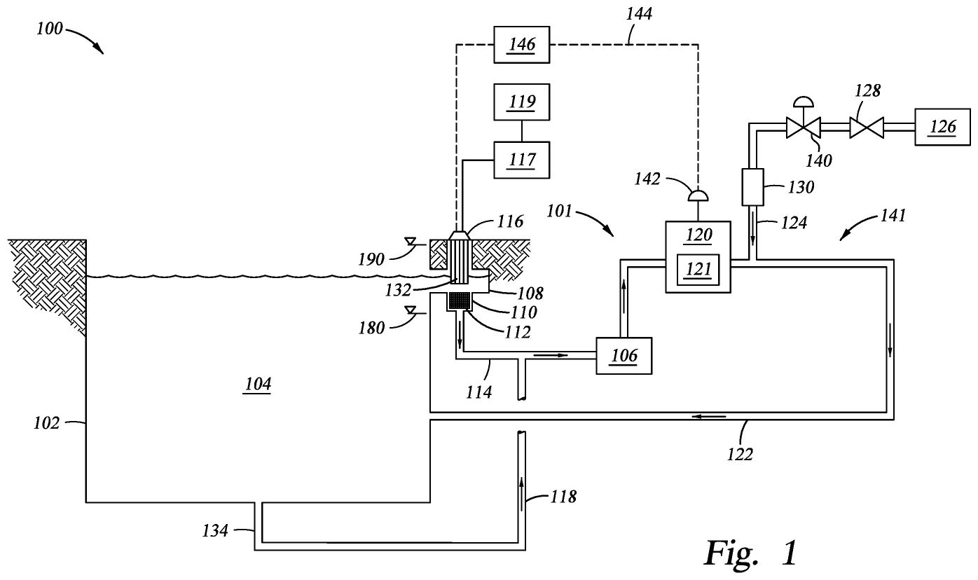

FIG. 1 is a block diagram of an example schematic arrangement of a pool system 100, according to one embodiment. The pool system 100 includes a basin 102 for containing water 104 therein. The basin 102 is fluidly coupled to a pump 106. A skimmer 108 is formed in a sidewall of the basin 102, the skimmer is disposed between the basin 102 and the pump 106, and the skimmer is fluidly coupled to the water 104 and the pump. The skimmer 108 includes a sump 110 wherein a basket 112 is disposed. The basket 112 functions to catch debris, such as leaves, pollen, and the like, and prevent the debris from entering a pipe 114 which is coupled between the sump 110 and the pump 106.

A skimmer cover plate 116 may be coupled to the skimmer 108. The skimmer cover plate 116 includes one or more sensors 132 which measure parameters of the water 104. The skimmer cover plate is solar powered with Bluetooth connectivity. In some exemplary embodiments, the skimmer cover unit 116 may include a level sensor assembly. The level sensor assembly may include a level sensor for detecting the water level in the basin 102. The level sensor assembly may also include a controller configured to communicate with the pressure monitoring device 200.

A drain 134 is formed in a bottom of the basin 102. The drain 134 is coupled to the pipe 114 and the pump 106 by a drain pipe 118. The drain 134 and the sump 110 deliver the water 104 contained within the basin 102 to the pump 106 for circulation through a filter 121 in a filter tank 120. The filter 121 is, for example, a sand filter or membrane filter, which removes contaminates, such as solid debris and algae, from water 104. The filtered water exits the filter 120 and returns to the basin 102 through a return pipe 122. The filter 120 imposes a large pressure drop on the circulated water 104 due to the filter media (not shown) disposed therein. The pump 106 provides sufficient pressure to the water 104 in order to overcome the pressure drop of the filter 121 and circulate the water 104 contained within the basin 102.

A refill pipe 124 is fluidly coupled to the return pipe 122 downstream of the filter tank 120. The refill pipe 124 is in fluid communication with a water source 126, such as a spigot or a municipal water header, among other sources, which provides water to refill the basin 102. It is understood the refill pipe 124 can be fluidly coupled to the basin 102 at other locations. For example, the refill pipe 124 can be fluidly coupled to a sidewall of the basin 102 adjacent to the return pipe 122.

A backflow preventer 130 is fluidly coupled to the refill pipe 124, and the refill valve 140 is located downstream from the backflow preventer and refill pipe, according to one embodiment. The backflow preventer 130 is, for example, a check valve, or the like, which prevents the water 104 circulated by the pump 106 through the filter tank 120 and the return pipe 122 from flowing the repast in the refill pipe 124. An isolation valve 128 is also fluidly coupled to the refill pipe 124. The isolation valve 128 is an on/off valve which functions to allow fluid communication between the basin 102 and the water source 126. For example, the isolation valve 128 can be opened in order to provide water to the basin 102 and can be closed in order to isolate the water source 126 therefrom. During operation of the equipment, the water source 126 is fluidly connected to the isolation valve 128, the isolation valve is fluidly coupled to the inlet conduit 202 of the refill valve 140, the outlet conduit 204 of the refill valve 140 is fluidly coupled to the backflow preventer 130, the backflow preventer is fluidly coupled to the refill pipe 124, the refill pipe is fluidly coupled to the filter tank 120 and the return pipe 122, the return pipe 122 is fluidly cooled to the water 104 in the basin 102, the water is fluidly coupled to the pipe 114, the pipe is fluidly coupled to the pump 106, the pump 106 is fluidly coupled to the filter tank 120, the water is fluidly coupled to the drain 134, and the drain is fluidly coupled to the drain pipe 118.

A refill valve 140 is fluidly coupled with the refill pipe 124, and may include an actuated controller 142. The refill valve 140 may also include a valve (e.g., a ball valve, a butterfly valve, a solenoid valve, a globe valve) or the like, which is operable to control flow of water from the water source 126 to the basin 102. The refill valve 140 is configured to provide on/off functionality as well as flow control (i.e., throttling) to control the flow rate of water from the water source 126 to the basin 102. In one example, the isolation valve 128 is removed and the refill valve 140 functions to isolate the water source 126 from the basin 102.

In an exemplary embodiment, the pool system may include a pressure monitoring device 200. The pressure monitoring device 200 may be configured to detect the conditions of the filter 121 and/or the filter tank 120 by determining the water pressure in the filter tank 120.

In some embodiments, the pressure monitoring device may connect to a wireless network via connection 144 and may communicate with a control program 146. The control program 146 is, for example, a hard coded program, a mobile application, a cloud-based machine learning program, or the like, which processes the signals from sensors (e.g., in the pressure monitoring device 200, in the skimmer cover unit 116). In one embodiment, the cloud-based analytics server, using machine learning algorithms or other artificial intelligence routines, takes in current and historical sensor data to predict pool conditions, metrics regarding the pool environment, and conditions of the pool equipment. The development of the machine learning algorithms is performed in the cloud using big data aggregation tools that train the models of the machine learning algorithms. The data gathered from the sensors (e.g., in the pressure monitoring device 200, in the skimmer cover unit 116) can show patterns and trends because the data reflects biological cycles such as temperature rising and falling, sunlight for a predicted time of day, and evaporation constants that correlate with temperature, and also reflects equipment life cycles, such as the durability or condition of the filter 121.

The pressure monitoring device 200 may be provided with a USB power connection. In some embodiments, when the pressure monitoring device 200 is connected to a power source, the pressure monitoring device 200 may communicate with the skimmer cover unit 116 and may transmit data to a user's wireless network. In some embodiments, the pressure monitoring device 200 may connect with the skimmer cover unit 116 and may remain connected when connected directly to a wireless network (e.g., Wi-Fi). In some embodiments, the pressure monitoring device may connect with the skimmer plate at certain intervals when connecting directly to a wireless network.

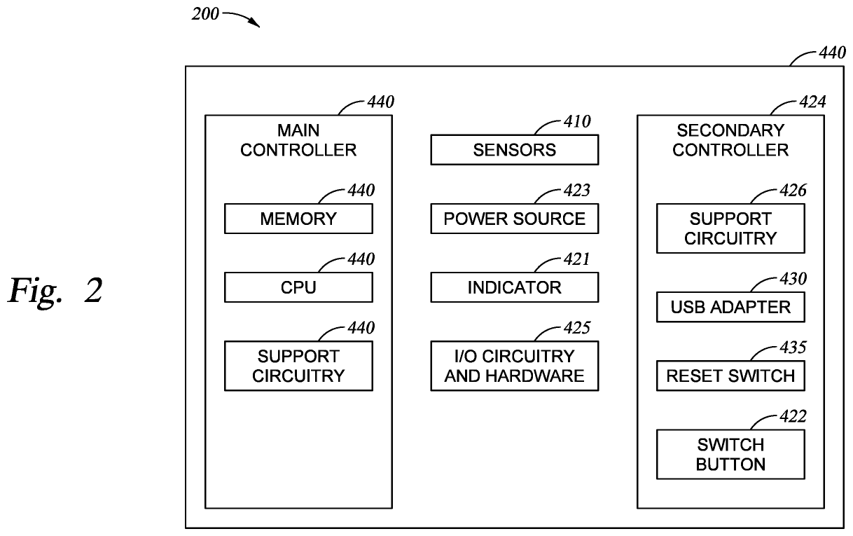

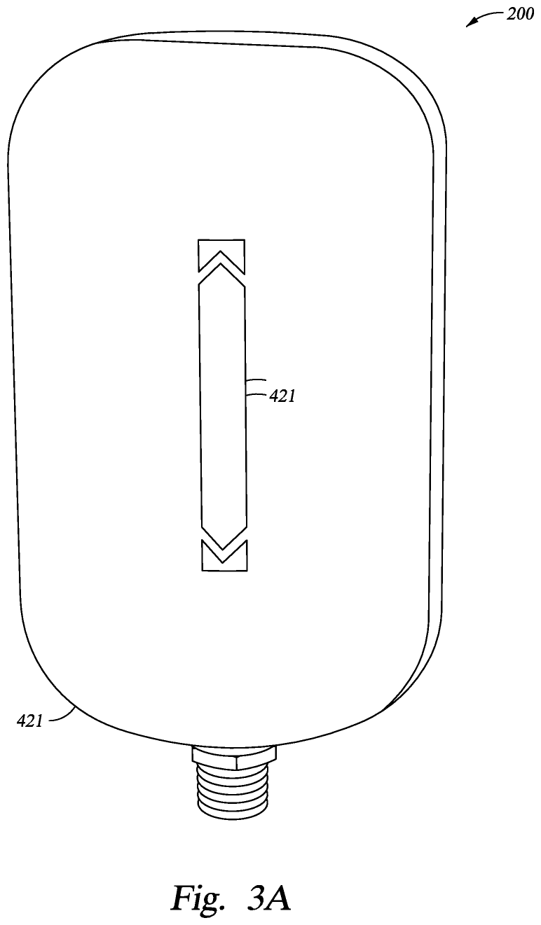

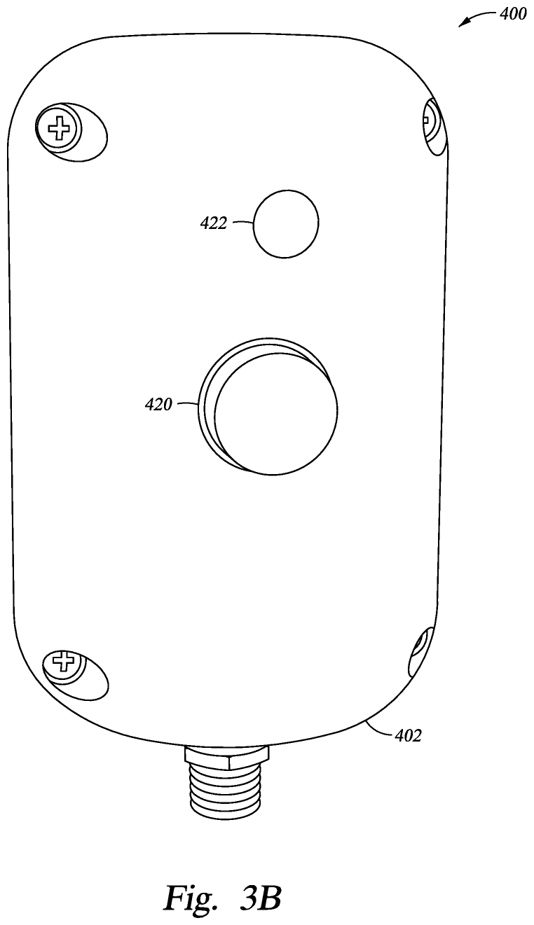

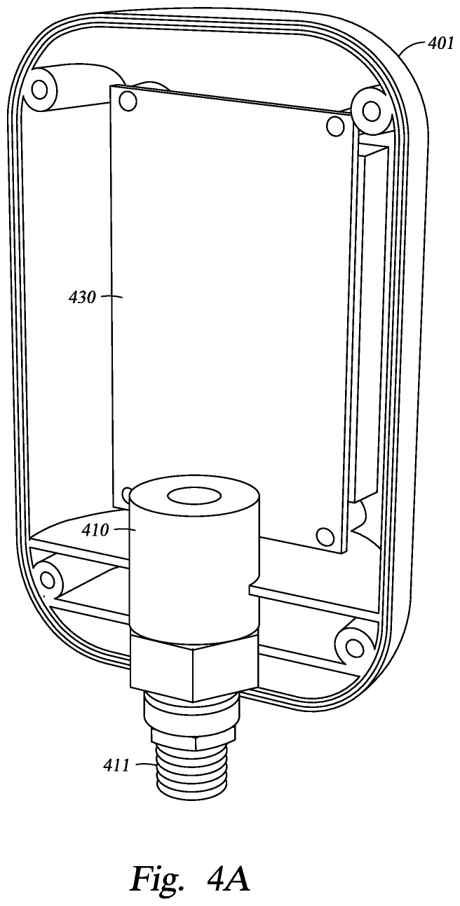

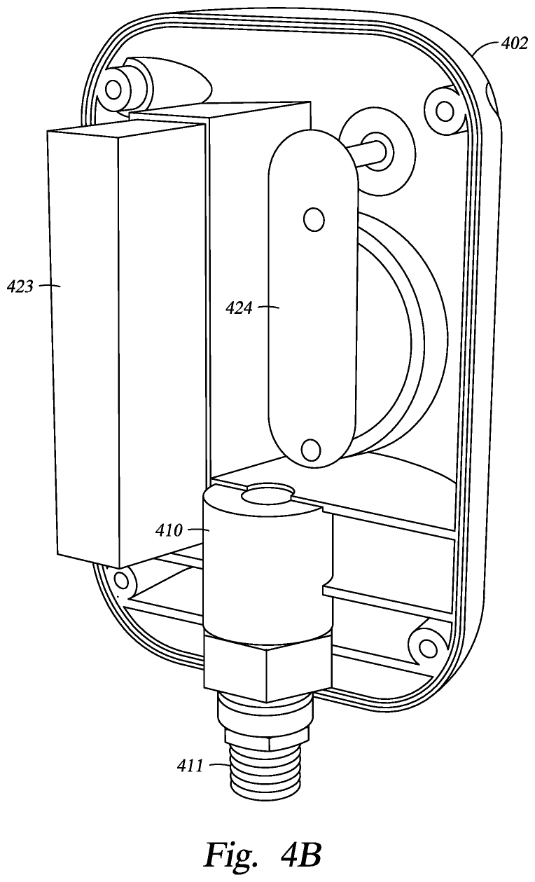

FIG. 2 is a block diagram of the pressure monitoring device 200. The pressure monitoring device 200 may include a sensor 410, a main controller 430, a secondary controller 424, a power source 423, an indicator 421, input/output (I/O) circuitry 425. The pressure monitoring device 200 may also include a housing 400 for the components of the pressure monitoring device 200 illustrated in FIGS. 3A-3B and 4A-4B. As illustrated in FIGS. 3A and 3B, the housing 400 may include a front enclosure portion 401 and a back enclosure portion 402. The front enclosure portion 401 and the back enclosure portion 402 may be coupled together and sealed (via a gasket seal) to provide a water-proof housing for the components of the pressure monitoring device 200.

The pressure monitoring device 200 may have a national pipe thread (NPT) connector 411 and may be mounted into an NPT fitting to the filter tank 120. In some cases, the filter tank 120 may have a fitting using ¼″ NPT thread sizes. However, adapter fittings are widely available on the market to accommodate all sizes for the water pressure sensor to be adapted and fitted. The filter tank 120 may be positioned on the pool equipment pad which provides an electrical connection. The pressure monitoring device 200, in addition to a power source 423, also includes a threaded adapter 430 for a universal serial bus (USB) IP67/68 connection and AC adaptor for continuous power. As illustrated in FIG. 3B, the housing 400 may include a waterproof threaded protective USB connector cap 420, which protects the USB adapter 430 and a device reset switch 435 provided underneath. When the cap is removed, a user may connect a USB cable to the USB adapter, which may power the device via a power source other than the power source 423. In some embodiments, the housing may include a wireless power charger, and the device may include circuitry to support wireless power charging. In some embodiments, the pressure monitoring device may connect to a wireless network (e.g., Wi-Fi) when the USB adapter 430 is in use and may serve as a BLE internet access point for other devices.

In some embodiments, the pressure monitoring sensor 410 may be a pressure transducer with a ceramic sensor core. A pressure transducer with a ceramic sensor may provide more accurate digital sensor readings to the main controller 430 disposed within the device housing 400. The housing 400 may be equipped with an indicator 421 (illustrated in FIG. 3A) to provide indications regarding filter conditions. For example, the indicator 421 may be a LED light bar providing visual (ex. Blue, orange and red) illuminations indicating filter condition. The LED light bar may also assist with device setup, wireless network setup, and Internet connectivity. In some embodiments, the indicator may be a LED or LCD screen providing visual feedback to the user.

In some embodiments, to manually determine pressure status of the filter tank 120, the device 200 may include a switch button 422. When a user depresses the switch button 422, the controller may be configured to respond to the depression of the switch button 422 by providing data to the indicator 421 . . . . The switch button 422 may be rubberized and may be over-molded into the housing 400. As mentioned, the switch button 422 may be depressed to activate a switch underneath.

The pressure monitoring device 200 may include I/O components 425. The I/O components 425 may include circuitry for the connection 144 illustrated in FIG. 1. The connection 144 can be a wired connection or a wireless connection, such as, but not limited to, Institute of Electrical and Electronics Engineers (IEEE) 802.11 (Wi-Fi), BLUETOOTH®, BLUETOOTH® Low Energy (BLE), global system for mobile communication (GSM), code division multiple access (CDMA), Enhanced Data Rate for GSM Evolution (EDGE), 3rd Generation (3G), Long Term Evolution (4G LTE), or 5th Generation (5G). The wireless connection 144 can include an antenna, and the antenna is configured for a wireless network, BLUETOOTH®, BLE, or cellular connection, or any combination of the above. The I/O circuitry may include an antenna mounted on the central processing unit (CPU) 445, main controller 430 disposed on a printed circuit board, or embedded into the front housing enclosure 401 or back housing enclosure 402. In some exemplary embodiments, the antenna may not protrude from the housing 400.

In an exemplary embodiment, a control program included on the main controller 430 disposed on a printed circuit board is coupled to the pressure sensor 410. The control program is, for example, a hard coded program, a mobile application, a cloud-based machine learning program, or the like, which processes the signals from the sensor 410. In one embodiment, the cloud-based analytics server, using machine learning algorithms or other artificial intelligence routines, takes in current and historical sensor data to determine current filter conditions and predict future behavior.

Pressure measurements based on the operating state of the pump 106 may determine running time of the pump 106, which can aid with longevity of the pump 106 and water cleaning efficiency.

A cloud-based machine learning program, or the like, combined with the measurements from the skimmer cover unit 116 may optimize running time of the pump 106 for optimum efficiency. The development of the machine learning algorithms may be performed in the cloud using big data aggregation tools that train the models of the machine learning algorithms. The data gathered from the skimmer cover unit 116 and pressure monitoring device 200 may show patterns and trends. The pressure monitoring device 200 uses predictions from the machine learning algorithms to be predictive with respect to when to clean or change the water filter 121 in the filter tank 120, and the optimum amount of run time for the pool pump 106 may be required to maintain healthy pool water. System information gathered by the pressure sensor 410 may be analyzed locally on the device, and the information is transmitted to the cloud for storage, processing, and analysis using the aforementioned machine learning or other artificial intelligence algorithms.

In an exemplary embodiment, one of the sensors of the skimmer cover unit 116 is a single photon avalanche diode light receiver that enables accurate distance measurements. The device 200 may use the sensor 410 to determine pool pump conditions when collaborated with the pool filter condition. For example, as a skimmer basket fills with debris, water flow may be restricted and may gradually increase the level of water in the skimmer 100. Dependent on the filter pressure, the pressure monitoring device 200 may determine where the source of the water flow restriction is occurring. The pressure monitoring device 200 may determine whether the filter basket of the skimmer is clogged or free of debris, or if the pump 106 or filter 120 is the cause of the water flow restriction. By understanding the water pressure at the filter tank, and drop of water level at the skimmer, the pressure monitoring device 200 may compile data to determine where the source of water restriction may be occurring. Similarly, the pressure monitoring device 200 may detect whether the pool pump 106 is on or off. In one embodiment, the pressure monitoring device 200 may use machine learning in order to accurately and precisely determine pool conditions based on the history of data from the sensors of the skimmer cover unit 116 and the pressure monitoring device 200.

In another embodiment, the pressure monitoring device 200 can determine run time of the pump 106 as a stand-alone device. Based on the water level change in the skimmer cover unit 116 and pressure at the filter tank 120, the pressure monitoring device 200 may determine and verify a more accurate pool pump run time via data algorithms. This data may be post-processed to build a pump “Circulation Profile”. The information may be fed back to the user or owner via a web or mobile application providing recommendations on pump efficiency, water quality and energy usage.

Due to the static position of the skimmer cover unit 116, pool water level may be monitored using a water level sensor or a laser driver and emitter with a single photon avalanche diode light receiver that enables accurate distance measurements. This sensor in the skimmer cover unit 116 may also have the ability to detect water interactions that reflect objects entering the water. This sensor n the skimmer cover unit 116 therefore may have the capability to function as a pool alarm. Through the cloud-based software of a pool monitoring system, the skimmer cover unit 116 informs the user of objects that have entered the pool based on requirements or settings. The sensors n the skimmer cover unit 116 can be enclosed in one or more plastic tubes for protection from dirt and debris and for photon absorption for accurate measurements. In some embodiments, the skimmer cover unit 116 may include a floating bobber that floats in a tube to assist with sensory accuracy.

In this exemplary embodiment, the skimmer cover unit 116 can remain powered on and connected to the pressure monitoring device 200 through BLE. As mentioned, the pressure monitoring device 200 may be connected to a network, such as a home electrical system with permanent wireless connection to transmit data to a cloud based monitoring system which could notify a user of objects that have entered the water. The protective tube can be adequately vented to prevent air pockets or other scenarios which could negatively affect measurements. The protective tube is removable for the user or owner to clean the water level sensor.

Returning to FIG. 2, the main controller 430 may be mounted in the front housing enclosure 401 (as illustrated in FIG. 4) and is coupled to the sensor 410. The main controller 430 may be disposed on a printed circuit board (e.g., PCBA) and may provide power to the sensor(s) 410. In some embodiments, the main controller may receive signals from the sensor 410. The main controller 430 may be configured to correlate to pressure readings inside the filter tank 120. The main controller 430 includes a central processing unit (CPU) 445, memory 440, and support circuitry 450. The CPU 445 may include a processor that is suitable for processing of instructional programs. The memory 440 may include random access memory, read-only memory, a hard disk drive, a universal serial bus (USB) drive, or other forms of digital storage. The support circuitry 450 may be coupled to the CPU 445 and may include cache, clock circuits, power supplies, and the like. In some embodiments, the main controller 430 may be coupled to I/O circuitry 425 and may send and/or receive data via the I/O circuitry 425.

The CPU 445 computes and transforms the data before transmitting the data to the cloud server by the connection 144, according to one embodiment. Accordingly, the main controller 430 may be configured to send and/or receive input/output data via the I/O circuitry 425 coupled thereto. In some embodiments, input and output via the I/O circuitry 425 may be used by the main controller 430 to provide an input to the sensor 410, which may be used to determine output pressure readings.

In another example, the I/O circuitry 425 may include a BLUETOOTH® or BLE transmitter. The I/O circuitry 425 may be wirelessly connected to an application that is, for example, operated by a user on a mobile device. The user can provide a signal to the main controller 430 through a signal via the I/O circuitry 425 using the application to obtain pressure readings from the pressure monitoring device 200.

The pressure monitoring device 200 may include a power source 423 (e.g., a rechargeable battery). In one embodiment, the pressure monitoring device 200 may be charged by an external solar panel through the USB cable connection. For example, the pressure monitoring device 200 may include a photovoltaic cell coupled to the housing 400 and to the power source 423. The power source 423, in such example, may convert power from the photovoltaic cell into a direct current power supply. In another exemplary embodiment, the device may be recharged in the absence of solar power or direct power source through the USB connection.

A secondary controller 424 may be disposed on a separate secondary printed circuit board and may be mounted to the back housing enclosure 402 and may have its own memory, CPU, and support circuitry 426. The secondary controller 424 may be configured as a subordinate controller to the main controller 430 and may function in conjunction with the main controller 430. The secondary controller 424 may include support circuitry 426 for the reset functionality via a reset switch 435, USB connection for the USB adaptor 430, and functionality for the switch button 422. The secondary controller 424 may include support circuitry for other functionalities and utility electrical connections.

As mentioned, in some embodiments, the pressure monitoring device 200 may include an indicator 421 providing visual feedback to a user. The visual indicator 421 may include, for example, a series of indicator lights or a screen, which display the status of water filter 121. In one example, the visual indicator 421 includes a light indicator configured to indicate the operational status of the water filter 121, such as high pressure (clogged), moderate pressure (requiring cleaning) and low pressure (clean). In some embodiments, the indicator 421 may include a plurality of light-emitting diodes (LED) in the form of a light bar, a ring, a circle, or any other geometric shape. In one embodiment, the light bar, ring, or geometric shape is insert molded into the front enclosure portion 401. The indicator 421 may be configured to change color depending on the data provided by the sensor 410, creating visual feedback of the water pressure in the filter tank 120. The light bar can be configured remotely or altered manually through a switch button 422 over-molded to the back enclosure portion 402. The visual indicator 421 provides information about the current, past, and predicted pressure readings. According to one embodiment, the indicator 421 may include a touch screen, wherein a user may manually function the pressure sensor.

Depending on water pressure, the indicator 421 (e.g., LED light bar, ring or other geometric shape) may change color to convey the status of the pool filter 121. As an example, if the water pressure was high, the indicator 421 may illuminate with a first color (e.g., red). If the water pressure was high and the filter 121 required correction but may still be fit for use, the indicator 421 may illuminate with a second color (e.g., orange). If the water pressure is in good condition, the indicator may illuminate in a third color (e.g., green, blue).

In some embodiments, the pressure monitoring device 200 may provide an auditory signal (e.g., an alarm, audio message) when the switch button 422 is activated. In such embodiments, the pressure monitoring device 200 may include circuitry providing audio output (e.g., a speaker).

In some exemplary embodiments, the pressure monitoring device 200 may include an audio assembly for audio input and output. The audio assembly may include a microphone assembly and a speaker assembly. The microphone assembly may be configured to detect audio input (e.g., equipment noises), so that a user may access the pressure monitoring device and may be able to listen to equipment noises via the microphone assembly. The speaker assembly may be configured to output audio feedback (e.g., an alarm).

In another exemplary embodiment, the pressure monitoring device may include a solar panel to improve efficiency and power generation in the absence of a power source.

In some exemplary embodiments, the pressure monitoring device 200 may include a camera to monitor equipment in field of view. For example, such that when the pressure monitoring device 200 is coupled to the filter tank 120 the camera of the pressure monitoring device 200 may be disposed near the top of the filter tank 120. In some exemplary embodiments, a user may access the camera via the pressure monitoring device 200 and may visually inspect the area near the filter tank 120. The area near the filter tank 120 may include pool equipment, and a user may use the camera to visually inspect and/or monitor pool equipment in the field of view of the camera.

In some exemplary embodiments, the pressure monitoring device 200 may include a vibration sensor. The vibration sensor may detect vibrations when attached and/or mounted to a device. For example, the vibration sensor may detect vibrations in the filter tank 120. In some embodiments, the vibration sensor may be mounted on an adjacent pool pump.

In some exemplary embodiments, the pressure monitoring device 200 may include a proximity sensor. The proximity sensor may detect that a person or object is near the pressure monitoring device 200, and thus near pool equipment. Upon detecting a person or object is near the pressure monitoring device, the pressure monitoring device may trigger an alert to the control program 146 or an on-site alert (e.g., an audio alarm from the pressure monitoring device 200). The distance for the alert by the proximity sensor may be configured by the user.

FIG. 3A is a front perspective view of a pressure monitoring device 200, and FIG. 3B is a rear perspective view of the pressure monitoring device 200. The front housing 401 contains a sensor 410 coupled to the main controller 430 housed therein. The sensor 410 includes an NPT thread 411 connected to the sensor housing for one or more sensors 410. As mentioned, the sensor 410 may include a pressure transducer with a ceramic sensor core to provide digital sensor readings.

As illustrated in FIG. 3A, the front enclosure portion 401 may include an indicator 421. In the exemplary embodiment, the indicator 421 comprises a light bar configured to indicate the pressure status.

The pressure monitoring device 200 may be installed on a new construction pool filter tank system or retrofitted to an existing system. The pressure monitoring device 200 can also be placed on any filter systems to determine upstream and downstream pressures.

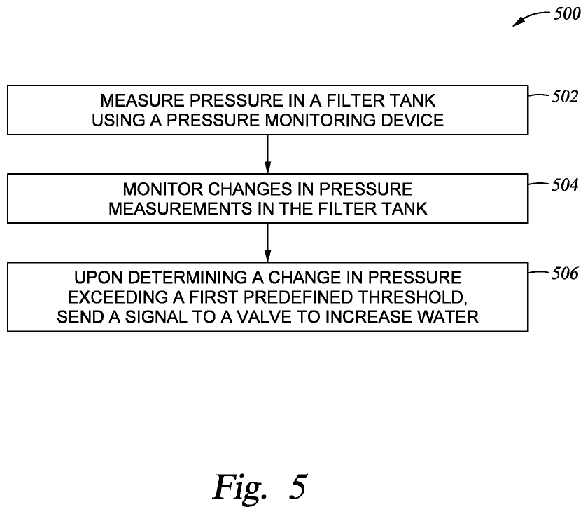

FIG. 5 is a flow diagram of a method for using the pressure monitoring device, according to an exemplary embodiment. The method 500 may be implemented as software components that are executed and run on one or more processors (e.g., controller 430 of FIG. 2). Further, the transmission and reception of signals by the pressure monitoring device 200 in method 500 may be enabled, for example by I/O circuitry (e.g., I/O circuitry 425 of FIG. 2).

The method 500 involves at 502, measuring pressure in a filter tank using a pressure monitoring device coupled to a filter tank. The pressure monitoring device may be the pressure monitoring device described in FIG. 2.

At 504, the pressure monitoring device 200 (e.g., via main controller 430) may monitor changes in pressure measurements in the filter tank by receiving pressure measurements from the sensor. The pressure monitoring device 200 may periodically receive pressure measurements from the sensor, or may continuously receive the pressure measurements from the sensor. In some embodiments, when the pressure monitoring device 200 monitors the changes in the pressure measurements, the pressure monitoring device 200 compares the pressure measurement to a predetermined range of measurements. Generally, a pool filter system are designed to operate in the 5-15 or 10-20 psi range. However, in some embodiments, the pressure measurements may be based on specifications of the pool, and may be based on a baseline pressure of the pool environment. Accordingly, the pressure measurement may be based on the baseline pressure of the pool environment and a standard deviation of pressure difference based on normal activity and condition of the pool environment.

At 506, the pressure monitoring device 200 may determine that a change in the pressure measurements in the filter tank exceeds a first predefined threshold and based upon this determination, the pressure monitoring device sends a signal to a valve to increase water in the basin to stop pump cavitation. For example, if the water in the basin 102 runs too low, the pump 106 may draw air and run the risk of cavitating or running dry. By sending a signal the valve 140 to open, the pressure monitoring device 200 may signal for an increase in water into the pool, which providing water for the pump to circulate. The first predefined threshold may be based on a baseline pressure of the pool environment. In some embodiments, the pressure monitoring device 200 may determine that one of the changes in the pressure measurements exceeds a second predefined threshold, and the pressure monitoring device 200 sends a second signal to the valve to close the valve. The second predefined threshold may be based on a baseline pressure of the pool environment.

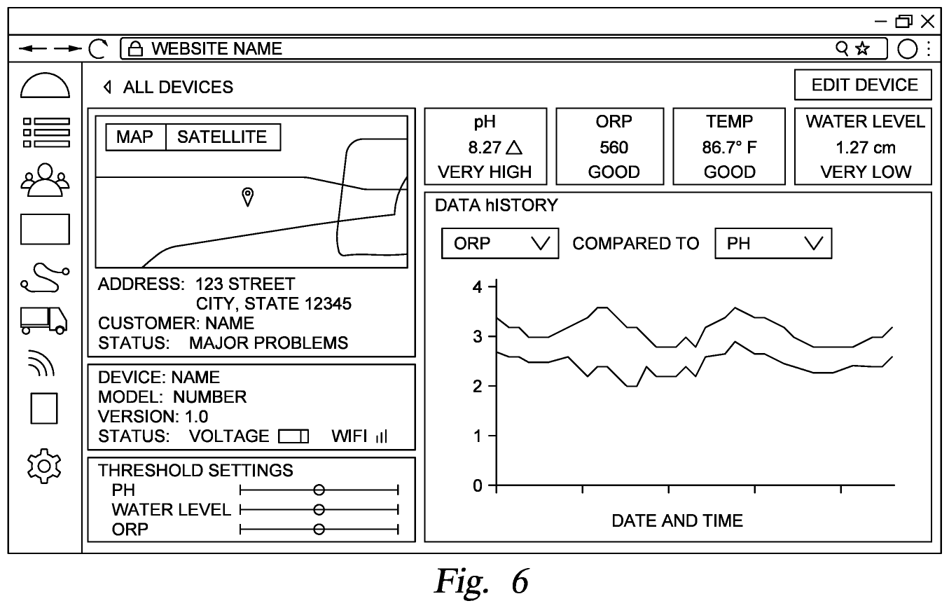

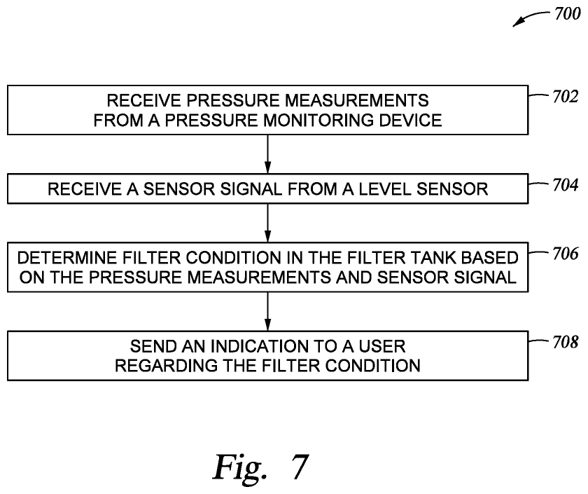

FIG. 6 is an exemplary graphic user interface (GUI) for using the skimmer cover unit 116 and the pressure monitoring device 200 of FIG. 1. In the exemplary embodiment, the pressure monitoring device 200 and the skimmer cover unit 116 may send signals to a cloud-based server 146, so the cloud-based server 146 may determine the condition of the filter 121. As mentioned, the pressure monitoring device 200 may use the sensor 410 to determine pool pump conditions when collaborated with the pool filter condition. Dependent on the filter pressure, the pressure monitoring device 200 may determine where the source of the water flow restriction is occurring. The pressure monitoring device 200 may determine whether the filter basket of the skimmer is clogged or free of debris, or if the pump 106 or filter 120 is the cause of the water flow restriction. By understanding the water pressure at the filter tank, and drop of water level at the skimmer, the pressure monitoring device 200 may compile data to determine where the source of water restriction may be occurring.

In some exemplary embodiments, the cloud-based server 146 may provide a GUI providing measurements from the signals from the skimmer cover unit 116 and from the pressure monitoring device. The exemplary GUI of FIG. 6 illustrates the GUI provided to a user from the cloud-based server 146. The exemplary GUI illustrates example pool metrics: pH, Oxidation-reduction potential (ORP), water temperature, and water level. The cloud-based server 146 may also provide these pool metrics in a graphical illustration over a period of time, as determined by the user. As illustrated, the cloud-based server 146, via the GUI, may also indicate problems in the pool environment. For example, the user is informed via the GUI that the pool pH is very high and therefore presents a problem.

In exemplary embodiments, the cloud-based server 146, via the GUI, may indicate a condition regarding the pool filter 121.

FIG. 7 is a flow diagram of a method by the cloud based server, according to an exemplary embodiment. The method 500 may be implemented as software components that are executed and run on one or more processors (e.g., cloud-based server 146 of FIG. 1).

The method 700 involves at 702, receiving pressure measurements from a pressure monitoring device. The pressure monitoring device may be the pressure monitoring device 200.

At 704, the cloud-based server receives a sensor signal from the level sensor. In some embodiments, the sensor signal indicates a water level of the basin 102. The sensor signal may also include other pool metrics, as described above.

At 706, the cloud-based server determines the filter condition in the filter tank based on the pressure measurements and sensor signal. As mentioned, by understanding the water pressure at the filter tank, and drop of water level at the skimmer, the cloud-based server 146 may determine where the source of water restriction may be occurring, and accordingly based on such determination, may determine the condition of the filter in the filter tank.

At 708, the cloud based server may send an indication to the user of the filter condition. In exemplary embodiments, the cloud-based server may send the filter condition indication via a GUI, as illustrated in FIG. 6.

The embodiments disclosed herein provide an automatic system for monitoring and maintaining the proper pressure of a pool filter. The burden of maintenance on an operator or pool owner is greatly reduced by the automatic monitoring of water pressure in the system disclosed. An operator of various pools can monitor the status of pool filter tanks through an interactive dashboard which can be optimized to plan for an efficient pool filter cleaning schedule. The data from this system can be processed in the cloud and pool filter cleaning schedules can be calculated and proposed by the system. This can lead to a reduced maintenance cycle lowering costs of operation. The embodiments herein advantageously can be retrofitted to existing pool systems further reducing costs of the system. The use of programmable applications and machine learning further improves the operations of the system. Though the disclosure is described herein for use with a pool, other applications, such as fountains, tanks, or other water-containing basins where monitoring of water pressure for filter tanks desired may also benefit from the disclosure.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Aspects of the present disclosure are described below with reference to flow chart illustrations and/or block diagrams of methods, apparatus (systems) and computer program products according to embodiments presented in this disclosure. The flow chart and block diagrams in the Figures illustrate the architecture, functionality, and operation of possible implementations of systems, methods, and computer program products according to various examples of the present disclosure. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flow chart illustration, and combinations of blocks in the block diagrams and/or flow chart illustration, can be implemented by special purpose hardware-based systems that perform the specified functions or acts or carry out combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

What is claimed is:

1. An apparatus for monitoring water pressure in a filter tank comprising:
a housing comprising a first enclosure portion, a second enclosure portion, and a gasket seal, the housing coupled to the filter tank;
a pressure sensor disposed within the housing and configured to monitor the water pressure in the filter tank; and
a first controller disposed within the housing, the controller communicatively connected to the pressure sensor and the controller configured to receive a sensor signal from the pressure sensor, and to determine the water pressure in the filter tank based on the sensor.

2. The apparatus of claim 1, further comprising:
an indicator configured to indicate information of the filter tank, the indicator visible through an opening in the housing.

3. The apparatus of claim 1, wherein the first controller is further configured to monitor the water pressure of the filter tank using the sensor signal based upon analysis of a measured parameter of water within the filter tank.

4. The apparatus of claim 1, further comprising:
a photovoltaic cell coupled to the housing and providing power to the apparatus.

5. The apparatus of claim 1, wherein the sensor comprises a pressure transducer having a ceramic sensor core.

6. The apparatus of claim 1, further comprising a camera to monitor equipment in field of view.

7. The apparatus of claim 1, further comprising a vibration sensor to mount on an adjacent pool pump.

8. The apparatus of claim 1, further comprising a microphone assembly to detect equipment noise.

9. The apparatus of claim 1, further comprising a proximity sensor to detect approaching objects.

10. The apparatus of claim 1, further comprising a second controller configured to provide user input to the first controller and to provide data to output to the user.

11. A method of controlling a water level within a basin comprising:
measuring pressure in a filter tank using a pressure monitoring device coupled to the filter tank;
monitoring, by a processor, changes in pressure measurements in the filter tank by receiving pressure measurements from a sensor of the pressure monitoring device;
upon determining, by a processor, one of the changes in the pressure measurements exceeds a first predefined threshold, sending a first signal to a valve to increase water to stop pump cavitation.

12. The method of claim 11, wherein monitoring the changes in the pressure measurements comprises:
comparing the pressure measurement to a predetermined range of measurements.

13. The method of claim 11, wherein the first signal to the valve comprises an indication to the valve to allow water to flow into a basin.

14. The method of claim 11, further comprising:
upon determining, by a processor, one of the changes in the pressure measurements exceeds a second predefined threshold, sending a second signal to the valve to close the valve.

15. The method of claim 11, wherein the pressure monitoring device comprises:
a housing comprising a first enclosure portion, a second enclosure portion, and a gasket seal, the housing coupled to the filter tank;
a pressure sensor disposed within the housing and configured to monitor water pressure in the filter tank; and
a first controller disposed within the housing, the controller communicatively connected to the pressure sensor and the controller configured to receive a sensor signal from the pressure sensor, and to determine the water pressure in the filter tank based on the sensor.

16. A system for monitoring of a condition of a filter of a pool environment, the system comprising:
a level sensor assembly positioned within a skimmer in the pool environment, the level sensor assembly comprising:
a sensor configured to detect water level of the pool environment; and
a first controller configured to transmit data regarding the water level detected by the sensor;
a pressure monitoring device coupled to a filter tank, the pressure monitoring device comprising:
a pressure sensor configured to detect the pressure in the filter tank;
a second controller configured to receive, from the first controller, the data regarding the water level, and to determine the condition of the filter based on the water level and the pressure in the filter tank.

17. The system of claim 16, wherein the level sensor assembly is coupled to a skimmer cover plate.

18. The system of claim 17, wherein the system further comprises a skimmer cover plate, the skimmer cover plate comprising the level sensor assembly;
wherein the first controller of the level sensor assembly is configured to analyze a measurement provided by the level sensor, and to wirelessly communicate with the second controller.

19. The system of claim 16, wherein the second controller is configured to execute machine-readable code for a cloud-based program.

20. The system of claim 16, wherein the pressure monitoring device further comprises:
a pressure transducer having a ceramic sensor core.
